(19) United States
(12) Patent Application Publication
(10) Pub. No.: US 2025/0031265 A1
(43) Pub. Date: Jan. 23, 2025

(54) METHOD AND APPARATUS FOR CONTEXT RESUMPTION

(71) Applicant: Telefonaktiebolaget LM Ericsson (publ), Stockholm (SE)

(72) Inventors: Xiaoming LI, SHANGHAI (CN); Qiong Song, SHANGHAI (CN); Chuanxin Liu, SHANGHAI (CN); Juying Gan, SHANGHAI (CN); Qian Chen, MÖLNDAL (SE)

(73) Assignee: Telefonaktiebolaget LM Ericsson (publ), Stockholm (SE)

(21) Appl. No.: 18/714,543

(22) PCT Filed: Nov. 30, 2022
(86) PCT No.: PCT/CN2022/135393

§ 371 Date: May 29, 2024

(30) Foreign Application Priority Data
Dec. 3, 2021 (WO) PCT/CN2021/135451

(51) Int. Cl. H04W 76/19; H04W 24/04

(52) U.S. Cl. CPC H04W 76/19; H04W 24/04

(57) ABSTRACT

Embodiments of the present disclosure provide methods and apparatuses for failure recovery. A method performed by a mobility management entity, comprising determining a failure occurs at a first session management entity. The method further comprises sending a first message to a terminal device, wherein the first message includes a Protocol Data Unit, PDU, session status information indicating that the first session management entity related PDU session is inactive.

### TECHNICAL FIELD

The non-limiting and exemplary embodiments of the present disclosure generally relate to the technical field of communications, and specifically to methods and apparatuses for failure recovery.

### BACKGROUND

This section introduces aspects that may facilitate a better understanding of the disclosure. Accordingly, the statements of this section are to be read in this light and are not to be understood as admissions about what is in the prior art or what is not in the prior art.

FIG. 1 schematically shows a high level architecture in the next generation network such as 5G. The system architecture of FIG. 1 may comprise some exemplary elements such as UE (User Equipment), AMF (Access and mobility Function), SMF (Session Management Function), AUSF (Authentication Service Function), UDM (Unified Data Management), PCF (Policy Control Function), AF (Application Function), NSSF (Network Slice Selection Function), NEF (Network Exposure Function), UPF (User plane Function) and NRF (NF Repository Function), (R)AN ((Radio) Access Network), SCP (Service Communication Proxy), DN (Data Network), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a packet data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf and Nsmf exhibited by NFs such as the NRF, the NEF, the AUSF, the UDM, the PCF, the AMF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

NF Set concept is introduced in Release 16 to provide a general solution for distribution, redundancy, and scalability within a NF Set. NF instances in a NF Set are interchangeable as they share the same context data while they may be geographically distributed. The support for NF Set concept can contribute to provide a standard geographical redundancy solution. It means if the operators deploy SMF set in the network, SMF redundancy can help to secure the redundancy of PDU (Packet Data Unit) session, and to avoid the impact to end users' service as much as possible, even if one SMF in the same set is totally out of service.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Each PDU session represents a PDU session established between the UE and an SMF. If there is no SMF set deployed, or if the worst case happens, e.g., one SMF set is totally out of service, then there is no good way for AMF to notify UE the affected PDU sessions' status.

FIG. 2 shows a flow chart of failure recover in the prior art. UE has two active PDU sessions: PDU session 1 and PDU session 2. At Step 201, UE is in CM_CONNECTED state, UE connects with the SMF 1 via PDU session 1 with UP (User plane) active, UE connects with SMF 2 via PDU session 2 without UP active. At step 202, SMF 2 fail and step 3 AMF detects the failure of SMF 2. At step 204, AMF sends the UE Context release Command to UE via AN (Access Network) to force UE to CM_IDLE state first, then at step 208, UE sends the Service Request message to AMF to sync the PDU session status in Service Request procedure, by marking the related PDU session status to “0” (inactive) in Service Accept to UE.

In this procedure, when the UE is forced to change to CM_IDLE state, the PDU session 2 which is served by SMF 2 will also be impacted, if the PDU session 2 is for MPS (Multimedia Priority Service) or MCS (Mission Critical Service) which are in high priority, these services will be impacted, so it will cause bad end user experience due to service interruption. Moreover, if AMF wants to trigger such restoration for all impacted UEs due to SMF1 failure, then there may be a signaling burst for RAN (Radio Access Network) side to release and re-establish the RRC (Radio Resource Control) connections.

To overcome or mitigate at least one above mentioned problems or other problems or provide a useful solution, the embodiments of the present disclosure propose an improved context resume solution.

In a first aspect of the disclosure, there is provided a mobility management entity. The method comprises: determining a failure occurs at a first session management entity. The method further comprises sending a first message to a terminal device, wherein the first message includes a Protocol Data Unit, PDU, session status information indicating that the first session management entity related PDU session is inactive.

In an embodiment, the determining a failure occurs at the first session management entity comprises: detecting the failure occurs at the first session management entity by the mobility management entity.

In an embodiment, the failure detection is made by the mobility management entity via monitoring communication between the mobility management entity and the first session management entity.

In an embodiment, the method further comprises obtaining the PDU session status information.

In an embodiment, the determining a failure occurs at the first session management entity comprises: receiving a status information of the first session management entity from another network, wherein the status information indicates that the failure occurs at the first session management entity.

In an embodiment, the method further comprises sending a second message to another network entity to subscribe the status information of the first session management entity.

In an embodiment, method further comprises determining the PDU session status information based on the status information of the first session management entity wherein the PDU session status information is received from the another network entity.

In an embodiment, the another network entity is Network Repository Function.

In an embodiment, the first message comprises at least one of the following: Non-Access-Stratum, NAS, Transport message, Configuration Update Command message, Notification message.

In an embodiment, the method further comprises receiving a PDU session establishment request message from the terminal device; the method further comprises selecting a second session management entity to serve the first session management entity related PDU session.

In an embodiment, the mobility management entity is Access and Mobility Management Function, and/or wherein the session management entity is Session Management Function.

In the second aspect of the disclosure, there is provided a method at a terminal device. The method comprises: receiving a first message from a mobility management entity, wherein the first message includes a Protocol Data Unit, PDU, session status information indicating that a first session management entity related PDU session is inactive because of a failure of the first session management entity. The method further comprises triggering a PDU session establishment procedure based on the PDU session status information.

In an embodiment, the triggering PDU session establishment procedure comprises: sending, to the mobility management entity, a PDU session establishment request message, notifying the mobility management entity to select a second session management entity to serve the first session management entity related PDU session.

In an embodiment, the first message comprises at least one of the following: Non-Access-Stratum, NAS, Transport message, Configuration Update Command message, Notification message.

In an embodiment, the mobility management entity is Access and Mobility Management Function, and/or the session management entity is Session Management Function.

In third aspect of the disclosure, there is provided an apparatus at a mobility management entity. The apparatus comprises a processor; and a memory coupled to the processor, said memory containing instructions executable by said processor, the apparatus is operative to determine a failure occurs at a first session management entity; the apparatus is further operative to send a first message to a terminal device, wherein the first message includes a Protocol Data Unit, PDU, session status information indicating that the first session management entity related PDU session is inactive.

In fourth aspect of the disclosure, there is provided an apparatus at terminal device. The apparatus comprises a processor; and a memory coupled to the processor, said memory containing instructions executable by said processor, the apparatus is operative to receive a first message from a mobility management entity, wherein the first message includes a Protocol Data Unit, PDU, session status information indicating that a first session management entity related PDU session is inactive because of a failure of the first session management entity; the apparatus is further operative to trigger a PDU session establishment procedure based on the PDU session status information.

In fifth aspect of the disclosure, there is provided a provided an apparatus at a mobility management entity. The apparatus comprises a determining unit configured to determine a failure occurs at a first session management entity. The apparatus further comprises a sending unit configured to sending a first message to a terminal device, the first message includes a Protocol Data Unit, PDU, session status information indicating that the first session management entity related PDU session is inactive.

In sixth aspect of the disclosure, there is provided an apparatus at terminal device. The apparatus comprises a receiving unit configured to receive a first message from a mobility management entity, the first message includes a Protocol Data Unit, PDU, session status information indicating that a first session management entity related PDU session is inactive because of a failure of the first session management entity. The apparatus further comprises a triggering unit configured to trigger a PDU session establishment procedure based on the PDU session status information.

In seventh aspect of the disclosure, there is provided a computer-readable storage medium storing instructions which when executed by at least one processor, cause the at least one processor to perform the method according to the first aspect of the disclosure.

In eighth aspect of the disclosure, there is provided a computer program product, comprising instructions which, when executed on at least one processor, cause the at least one processor to carry out the method according to the first aspect of the disclosure.

In ninth aspect of the disclosure, there is provided a computer-readable storage medium storing instructions which when executed by at least one processor, cause the at least one processor to perform the method according to the second aspect of the disclosure.

In the tenth aspect of the disclosure, there is provided a computer program product, comprising instructions which, when executed on at least one processor, cause the at least one processor to carry out the method according to the second aspect of the disclosure.

Many advantages may be achieved by applying the proposed solution according to embodiments of the present disclosure. By the mechanism in this invention, the PDU session status synchronization is made between AMF and UE instead of between SMF and UE. when one SMF is down, the UE will not be forced to change to CM_IDLE state, therefore, the signaling for the failure recover is reduced, and the impact to other services which is served by other SMF can be also reduced or even be eliminated.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the 5G network.

FIG. 2 shows a flowchart of a system method according to the prior art.

FIG. 3 shows a flowchart of a method according to one embodiment of the present disclosure.

FIG. 4 shows a flowchart of a method according another embodiment of the present disclosure.

FIG. 5 shows a block diagram showing an apparatus suitable for use in practicing some embodiments of the disclosure.

FIG. 6 shows a flowchart of a system method according one embodiment of the present disclosure.

FIG. 7 shows a block diagram showing an apparatus at the mobility management entity according one embodiment of the present disclosure.

FIG. 8 shows a block diagram showing an apparatus at the terminal device according one embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR). In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the 5G communication protocols, and/or any other protocols either currently known or to be developed in the future.

The term “entity” used herein refers to a network entity in a communication network. The “entity” can be implemented in a physical network node, or in a virtual network node which perform a function by logical resources in more than one physical network node. The “entity” can be implemented in a centralized way, or in a distributed way. The “entity” can also be implemented in the cloud.

The term “network function (NF)” refers to any suitable function which can be implemented in a network node (physical or virtual) of a communication network. For example, the 5G system (5GS) may comprise a plurality of NFs such as AMF, SMF, AUSF, UDM, PCF, AF, NEF, UPF and NRF, (R)AN, SCP, etc. In other embodiments, the network function may comprise different types of NFs for example depending on a specific type of network.

The terminal device may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. a terminal device may be designed to transmit information to a network on a predetermined schedule, when triggered by an internal or external event, or in response to requests from the communication network.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

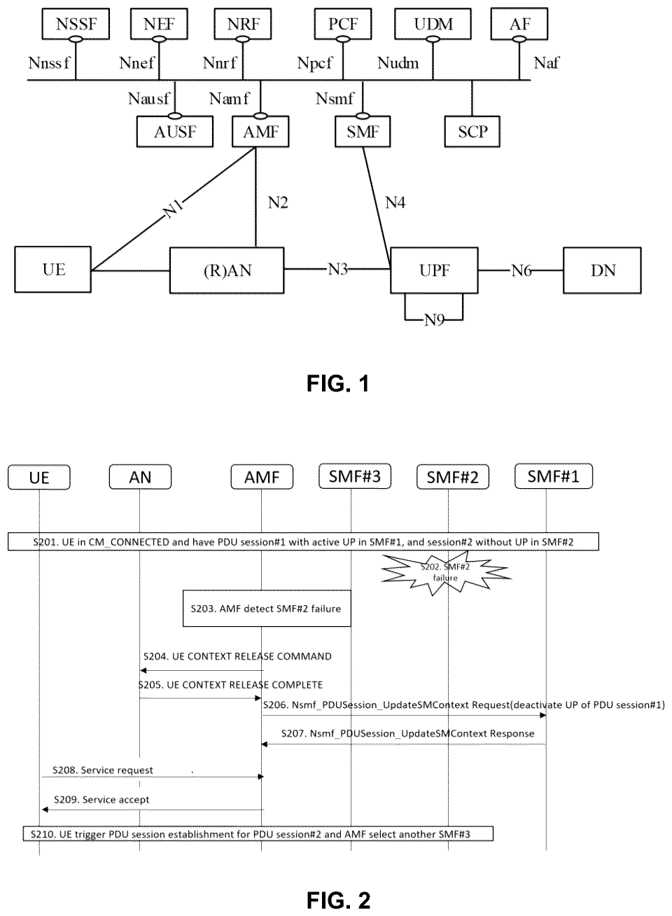

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

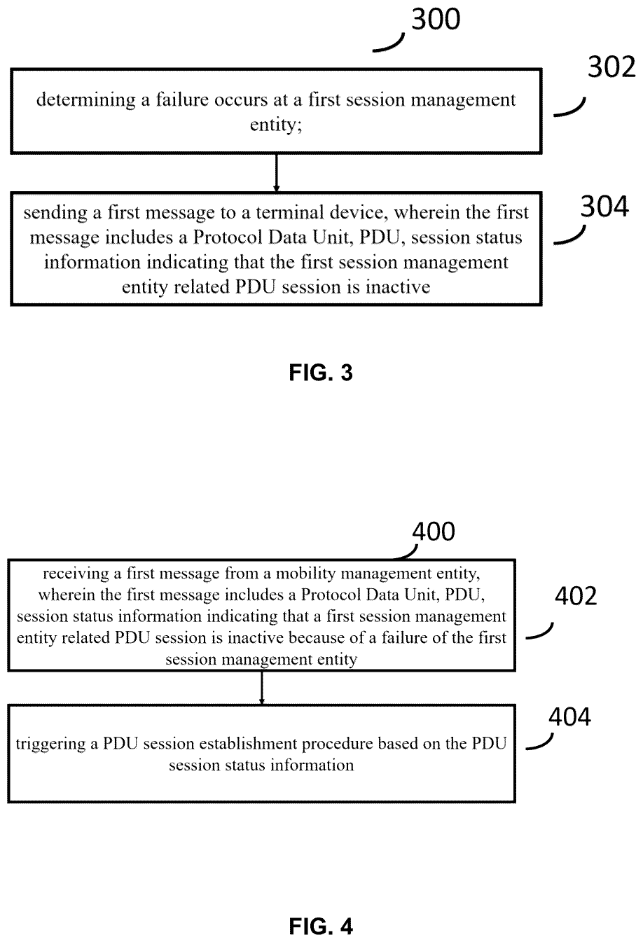

FIG. 3 shows flowcharts of methods 300 according to an embodiment of the present disclosure, which may be performed by an apparatus implemented in or at or as a mobility management entity or communicatively coupled to the mobility management entity. As such, the apparatus may provide means or modules for accomplishing various parts of the method 300 as well as means or modules for accomplishing other processes in conjunction with other components.

At block 302, the mobility management entity determining a failure occurs at a first session management entity. The mobility management entity can be an Access and Mobility Management Function. The first session management entity can be a Session Management Function.

The mobility management entity may determine the failure in various ways. In the first embodiment, the mobility management entity may detect the failure occurs at the first session management entity by itself. The mobility management entity may monitor the communication between itself and the first session management entity, for example, the AMF may send a Ping request message regularly to the first SMF. After receiving the Ping request message, the first SMF sends a response to the mobility management entity. When the AMF hasn't received the response for more than a fixed interval, the AMF determine that a failure occurs at the first SMF. Based on the detection of the first SMF failure, the AMF may further determine the related PDU session status information which indicating that the first SMF related PDU session is inactive.

In the second embodiment, the mobility management entity determining a failure occurs at the first session management entity by receiving a status information of the first session management entity from another network, for example: Network Repository Function, NRF. The NRF detects the failure of the first SMF. First, the AMF sends a subscription request message to the NRF to subscribe the status information of the first SMF. After receiving the subscription request message, the NRF monitors the status of the first SMF through a Heart-Beat procedure. When NRF detects that the first SMF status changes to Suspended, it sends the status information of the first SMF to the AMF. After AMF receives the status information of the first SMF, the AMF determines the PDU session status information based on the status information of the first session management entity.

At block 304, the mobility management entity sends a first message to a terminal device, wherein the first message includes a Protocol Data Unit, PDU, session status information indicating that the first session management entity related PDU session is inactive. The first message may be Non-Access-Stratum, NAS, Transport message, Configuration Update Command message or Notification message.

After determining that a failure occurs at a first SMF, the AMF doesn't send the UE Context Command message to UE to make UE into the CM_IDLE state as the FIG. 2 shows, so the UE is still in CM_CONNECT state, the other services which are served by other normal SMFs are not impacted.

In one embodiment, the first message is the NAS Transport message, specifically, is the DL NAS (Down Link Non-Access-Stratum) Transport message. The DL NAS Transport message is sent from the AMF to UE and is used for carrying NAS information. The DL NAS TRANSPORT message transports message payload and associated information to the UE. See table 1. The IE “PDU session status” is newly added.

TABLE 1
DL NAS TRANSPORT message content

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | ½ |
| | | 9.3 | | | |
| | Spare half octet | Spare half octet | M | V | ½ |
| | | 9.5 | | | |
| | DL NAS TRANSPORT message | Message type | M | V | 1 |
| | identity | 9.7 | | | |
| | Payload container type | Payload container type | M | V | ½ |
| | | 9.11.3.40 | | | |
| | Spare half octet | Spare half octet | M | V | ½ |
| | | 9.5 | | | |
| | Payload container | Payload container | M | LV-E | 3-65537 |
| | | 9.11.3.39 | | | |
| 12 | PDU session ID | PDU session identity 2 | C | TV | 2 |
| | | 9.11.3.41 | | | |
| 24 | Additional information | Additional information | O | TLV | 3-n |
| | | 9.11.2.1 | | | |
| 58 | 5GMM cause | 5GMM cause | O | TV | 2 |
| | | 9.11.3.2 | | | |
| 37 | Back-off timer value | GPRS timer 3 | O | TLV | 3 |
| | | 9.11.2.5 | | | |
| xx | PDU session status | PDU session status | O | TLV | 4-34 |
| | | 9.11.3.44 | | | |

The PDU session status information element is to indicate the state of each PDU session that can be identified by a PDU session identity. The content of the PDU session status IE is defined in clause 9.11.3.44 of the 3GPP TS 24.501 V17.4.1 (Herein the contents of standard 3GPP TS 23.273 V16.7.0 are all incorporated in the invention).

In another embodiment, the first message is Configuration Update Command message. The Configuration Update Command message is sent from AMF to UE to initiate the generic UE configuration update procedure. The purpose of this procedure is to:
a) allow the AMF to update the UE configuration for access and mobility management-related parameters decided and provided by the AMF by providing new parameter information within the command; or
b) request the UE to perform a registration procedure for mobility and periodic registration update towards the network to update access and mobility management-related parameters decided and provided by the AMF.

The IE can be added into the CONFIGURATION UPDATE COMMAND message as following. (The detailed information of the CONFIGURATION UPDATE COMMAND message is defined in clause 9.11.3.44 of the 3GPP TS 24.501 V17.4.1)

TABLE 2
CONFIGURATION UPDATE COMMAND message content

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | ½ |
| | | 9.3 | | | |
| | Spare half octet | Spare half octet | M | V | ½ |
| | | 9.5 | | | |
| | Configuration update command | Message type | M | V | 1 |
| | message identity | 9.7 | | | |
| . . . | | | | | |
| . . . | | | | | |
| xx | PDU session status | PDU session status | O | TLV | |
| | | 9.11.3.44 | | | |

In another embodiment, the first message is NOTIFICATION message. The NOTIFICATION message is sent by the AMF to the UE to notify the UE to initiate a service request procedure.

The IE PDU session status can be added into the NOTIFICATION message as following. (The detailed information of the NOTIFICATION message is defined in clause 8.2.23.1 of the 3GPP TS 24.501 V17.4.1)

TABLE 3
NOTIFICATION message content

| IEI | Information Element | Type/Reference | Presence | Format | Length |
|---|---|---|---|---|---|
| | Extended protocol discriminator | Extended protocol discriminator | M | V | 1 |
| | | 9.2 | | | |
| | Security header type | Security header type | M | V | ½ |
| | | 9.3 | | | |
| | Spare half octet | Spare half octet | M | V | ½ |
| | | 9.5 | | | |
| | Notification message identity | Message type | M | V | 1 |
| | | 9.7 | | | |
| | Access type | Access type | M | V | ½ |
| | | 9.11.2.1A | | | |
| | Spare half octet | Spare half octet | M | V | ½ |
| | | 9.5 | | | |
| xx | PDU session status | PDU session status | O | TLV | |
| | | 9.11.3.44 | | | |

After receiving the DL NAS Transport message or Configuration Update Command message or Notification message which includes the PDU session status information, the UE knows that the first session management entity related PDU session is inactive, then UE triggers PDU session establishment. In one embodiment, UE sends a PDU session establishment request message to the AMF. After receiving the PDU session establishment request message, the AMF select a new SMF to serve the first SMF related PDU session.

Through the proposed invention, when SMF failure happens, the AMF directly sends the session status information to the UE without forcing UE into CM_IDLE state, then the UE can only trigger PDU session establishment for the inactive PDU session, other PDU sessions which are served by other normal SMFs are not impacted, therefore the user service experience can be improved.

FIG. 4 shows flowcharts of methods 400 according to an embodiment of the present disclosure, which may be performed by an apparatus implemented in or at or as a terminal device or communicatively coupled to the terminal device. As such, the apparatus may provide means or modules for accomplishing various parts of the method 400 as well as means or modules for accomplishing other processes in conjunction with other components.

At step 402, the terminal device receives a first message from a mobility management entity, the first message includes a Protocol Data Unit, PDU, session status information indicating that a first session management entity related PDU session is inactive because of a failure of the first session management entity. The mobility management entity is the AMF, and the first session management entity is the SMF.

The first message may be NAS Transport message or Configuration Update Command message or Notification message. The detailed implementation has already been described in above.

At step 404, UE triggers a PDU session establishment procedure based on the PDU session status information. The PDU session establishment procedure is implemented by sending, to the AMF, a PDU session establishment request message, notifying the AMF to select a second SMF to serve the first SMF related PDU session.

After receiving the PDU session establishment request message, AMF selects a new SMF to serve the first failed SMF related PDU session.

Through the proposed invention, when SMF failure happens, the UE receives the session status information directly from the AMF without being forced into CM_IDLE state, then the UE can only trigger PDU session establishment for the inactive PDU session, other PDU sessions which are served by other normal SMFs are not impacted, therefore the user service experience can be improved.

FIG. 6 shows a flowchart of a system method according one embodiment of the present disclosure.

At step 601, AMF subscribes to the NRF to receive notifications of changes of the SMF Profile.

At step 602, UE in CM_CONNECTED and have PDU session 1 with active UP, and session 2 without UP in SMF2.

At step 603, SMF 2 failure happens.

At step 604, NRF detects that SMF 2 fails by Heart-Beat procedure as specified in clause 5.2.2.3.2 of 3GPP TS 29.510 V17.3.0 (2021 September) (Herein the contents of standard 3GPP TS 23.273V16.7.0 are all incorporated in the invention.). In the Heart-Beat procedure, each NF that has previously registered in NRF shall contact the NRF periodically (Heart-Beat), by invoking the NFUpdate service operation, in order to show that the NF is still operative. When the NRF detects that a given NF has not updated its profile for a configurable amount of time (longer than the heart-beat interval), the NRF changes the status of the NF to SUSPENDED and considers that the NF and its services can no longer be discovered by other NFs via the NFDiscovery service. The NRF notifies NFs subscribed to receiving notifications of changes of the NF Profile that the NF status has been changed to SUSPENDED.

At step 605, the NRF notifies AMFs which have subscribed to receive notifications of changes of the SMF #2 Profile that the NFStatus of SMF #2 is changed to SUSPENDED.

At step 607, AMF gets to know that the SMF 2 failure through NRF via Nnrf_NF status notify request/response message. In an alternative way, the AMF may detect the SMF 2 failure by itself through monitoring the communication (HTTP ping request/response) between AMF and SMF as shown in step 606.

At step 608, AMF triggers appropriate session restoration for the PDU sessions established in SMF #2 by sending DL NSA transport or Configuration Update Command with PDU session status indicating that the 5GSM (5GS Session Management) state of the corresponding PDU session is PDU SESSION INACTIVE.

At step 609, after UE receives the PDU session status, UE triggers the PDU session establishment procedure to AMF, then AMF selects a new SMF 3 to serve the impacted PDU session.

By introducing the new way between AMF and UE to sync the latest PDU Session status, when SMF failure happens in the scenario that no other alternative SMF instance in the same set or no SMF set deployed, the UE service on the affected PDU session can be restored quickly without making UE change to CM_IDLE status.

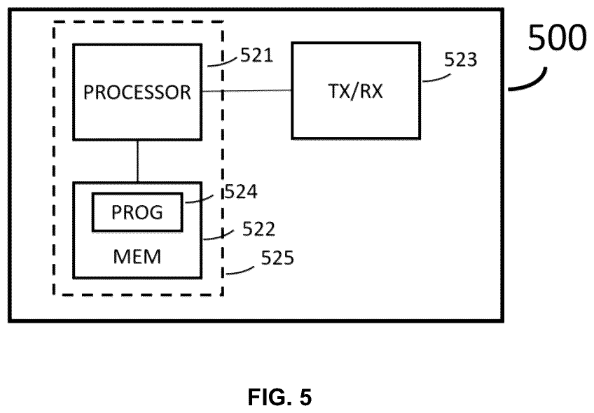

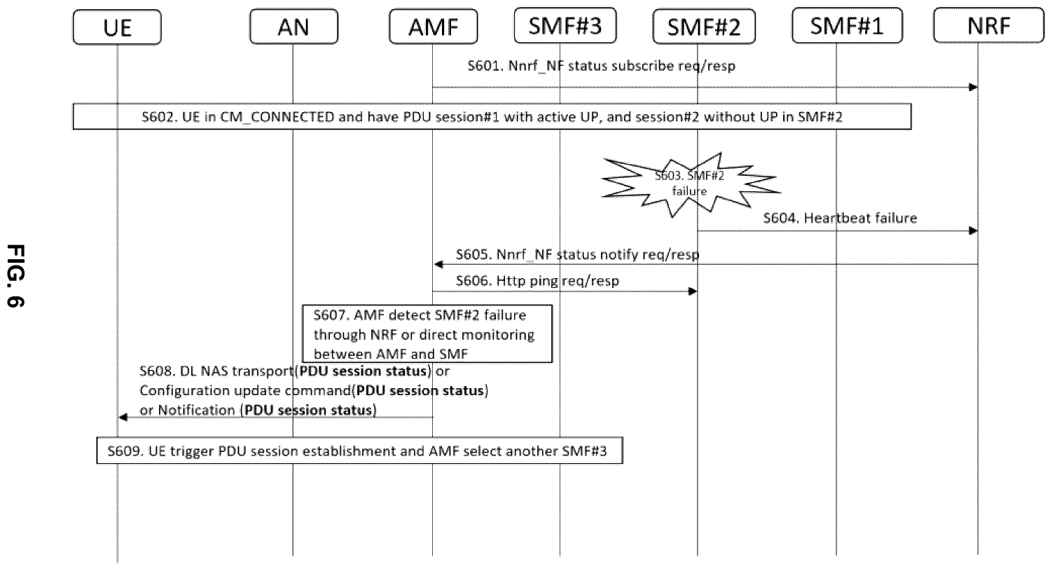

FIG. 5 is a block diagram showing an apparatus suitable for use in practicing some embodiments of the disclosure. For example, any one of the or above may be implemented through the apparatus 500.

The apparatus 500 comprises at least one processor 521, such as a DP, and at least one MEM 522 coupled to the processor 521. The apparatus 500 may further comprise a transmitter TX and receiver RX 523 coupled to the processor 521. The MEM 522 stores a PROG 524. The PROG 524 may include instructions that, when executed on the associated processor 521, enable the apparatus 520 to operate in accordance with the method at the mobility management entity or with the method at the terminal device. A combination of the at least one processor 521 and the at least one MEM 522 may form processing means 525 adapted to implement the method at the mobility management entity or with the method at the terminal device as shown above.

Various embodiments of the present disclosure may be implemented by computer program executable by one or more of the processor 521, software, firmware, hardware or in a combination thereof.

The MEM 522 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 521 may be of any type suitable to the local technical environment, and may include one or more of general purpose computers, special purpose computers, microprocessors, digital signal processors DSPs and processors based on multicore processor architecture, as non-limiting examples.

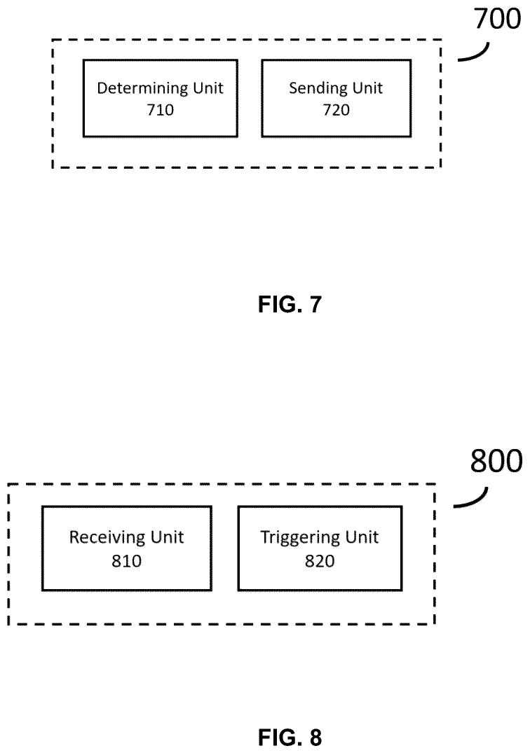

Correspondingly to the method 300 as described above, a mobility management entity is provided. FIG. 7 is a block diagram of a mobility management entity 700 according to an embodiment of the present disclosure.

The mobility management entity 700 is operative to perform the method 300 as described above in connection with FIG. 3 The mobility management entity 700 includes a determining unit 710 configured to determine a failure occurs at a first session management entity. The mobility management entity 700 further includes a sending unit 720 configured to send a first message to a terminal device, the first message includes a Protocol Data Unit, PDU, session status information indicating that the first session management entity related PDU session is inactive.

The units 710 and 720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

Correspondingly to the method 400 as described above, a terminal device is provided. FIG. 8 is a block diagram of a terminal device 800 according to an embodiment of the present disclosure.

The terminal device 800 is operative to perform the method 600 as described above in connection with FIG. 4. The terminal device 800 includes a receiving unit 810 configured to receive a first message from a mobility management entity, the first message includes a Protocol Data Unit, PDU, session status information indicating that a first session management entity related PDU session is inactive because of a failure of the first session management entity. The terminal device 800 further includes a triggering unit 820 configured to triggering a PDU session establishment procedure based on the PDU session status information.

The units 810 and 820 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

According to an aspect of the disclosure it is provided a computer program product being tangibly stored on a computer readable storage medium and including instructions which, when executed on at least one processor, cause the at least one processor to carry out any of the methods related to the mobility management entity as described above.

According to an aspect of the disclosure it is provided a computer program product being tangibly stored on a computer readable storage medium and including instructions which, when executed on at least one processor, cause the at least one processor to carry out any of the methods related to the terminal device as described above.

According to an aspect of the disclosure it is provided a computer-readable storage medium storing instructions which when executed by at least one processor, cause the at least one processor to carry out any of the methods related to the mobility management entity as described above.

According to an aspect of the disclosure it is provided a computer-readable storage medium storing instructions which when executed by at least one processor, cause the at least one processor to carry out any of the methods related to the terminal device as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a mobility management entity, comprising:
determining a failure occurs at a first session management entity; and
sending a first message to a terminal device, wherein the first message includes a Protocol Data Unit, PDU, session status information indicating that the first session management entity related PDU session is inactive.

2. The method according to claim 1, wherein the determining a failure occurs at the first session management entity comprises:
detecting the failure occurs at the first session management entity by the mobility management entity.

3. The method according to claim 2, wherein the failure detection is made by the mobility management entity via monitoring communication between the mobility management entity and the first session management entity.

4. The method according to claim 1, the method further comprises:
obtaining the PDU session status information.

5. The method according to claim 1, wherein the determining a failure occurs at the first session management entity comprises:
receiving a status information of the first session management entity from another network, wherein the status information indicates that the failure occurs at the first session management entity.

6. The method according to claim 5, the method further comprises:
sending a second message to the another network entity to subscribe the status information of the first session management entity.

7. The method according to claim 5, the method further comprises:
determining the PDU session status information based on the status information of the first session management entity.

8. The method according to claim 5, wherein the another network entity is Network Repository Function.

9. The method according to claim 1, wherein the first message comprises at least one of the following:
Non-Access-Stratum, NAS, Transport message,
Configuration Update Command message,
Notification message.

10. The method according to claim 1, the method further comprises:
receiving a PDU session establishment request message from the terminal device; and
selecting a second session management entity to serve the first session management entity related PDU session.

11. The method according to claim 1, wherein the mobility management entity is Access and Mobility Management Function, or
wherein the session management entity is Session Management Function.

12. A method at a terminal device, comprising:
receiving a first message from a mobility management entity, wherein the first message includes a Protocol Data Unit, PDU, session status information indicating that a first session management entity related PDU session is inactive because of a failure of the first session management entity; and
triggering a PDU session establishment procedure based on the PDU session status information.

13. The method according to claim 12, wherein the triggering PDU session establishment procedure comprises:
sending, to the mobility management entity, a PDU session establishment request message, notifying the mobility management entity to select a second session management entity to serve the first session management entity related PDU session.

14. The method according to claim 12, wherein the first message comprises at least one of the following:
Non-Access-Stratum, NAS, Transport message,
Configuration Update Command message,
Notification message.

15. The method according to claim 12, wherein the mobility management entity is Access and Mobility Management Function, or
wherein the session management entity is Session Management Function.

16. A mobility management entity, comprising:
a processor; and
a memory coupled to the processor, said memory containing instructions executable by said processor, whereby said first mobile management node is operative to:
determine a failure occurs at a first session management entity; and
send a first message to a terminal device, wherein the first message includes a Protocol Data Unit, PDU, session status information indicating that the first session management entity related PDU session is inactive.

17-19. (canceled)

20. A non-transitory computer-readable storage medium storing instructions which when executed by at least one processor, cause the at least one processor to perform the method according to claim 1.

21. A non-transitory computer-readable storage medium storing instructions which when executed by at least one processor, cause the at least one processor to perform the method according to claim 12.
